(19) United States
(12) Patent Application Publication
(10) Pub. No.: US 2007/0000067 A1
(43) Pub. Date: Jan. 4, 2007

(54) Use of an effervescent product to clean soiled dishes by hand washing

(76) Inventors: Jichun Shi, Liberty Twsp., OH (US); Penny Sue Dirr, Fairfield, OH (US); Michael Stanford Showell, Cincinnati, OH (US); Frank William Denome, Cicinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/477,506

(22) Filed: Jun. 29, 2006

Related U.S. Application Data
(60) Provisional application No. 60/695,130, filed on Jun. 29, 2005.

(51) Int. Cl. C11D 3/00

(52) U.S. Cl. 8/137

(57) ABSTRACT

The use of an effervescent product to clean soiled dishes and methods of cleaning soiled dishes by hand washing.

### CROSS REFERENCE TO RELATED APPLICATION

This application claims benefit of and priority to U.S. Provisional Application Ser. No. 60/695,130, filed Jun. 29, 2005.

### FIELD OF THE INVENTION

The present invention relates to the use of or a method of using an effervescent product to clean soiled dishes by hand washing. The composition of the effervescent product is further described herein.

### BACKGROUND OF THE INVENTION

Washing dishes and utensils is generally done either by hand washing or by an automatic dishwashing machine. Automatic dishwashing machine cleaning compositions take several forms such as granules, gels, and unit does materials (solids and gels). Hand washing involves diluting a viscous liquid in a volume of water either in a sink or a container of some sort. Difficult to clean soils on dishes such as the ones that result from cooking or baking are often difficult to remove by hand washing. These stains are equally difficult to remove from dish surfaces in an automatic dishwashing machine. Often these dishes are soaked for long periods of time and then scraped and/or scrubbed to remove the cooked on/baked on soils. Commonly, scrubbing and scouring materials such as brushes or steel wool materials such as the one marketed under the name Brillo® are utilized to remove tough cooked on/baked on soils from dish surfaces.

Effervescent systems have been employed in specific types of cleaning and personal care compositions in the past. Dry products with effervescent systems include denture cleaners, toilet cleaners, window cleaners, medical instrument cleaner, jewelry cleaner and golf club cleaner, laundry detergents, hair and skin cleaners, drain cleaners and automatic dishwashing detergents. Also for liquid forms, for example, effervescent agents have been incorporated into non-aqueous liquid detergent compositions. Further, effervescent systems, or parts thereof, have been used in non-detergent (i.e., non-surfactant) carpet cleaning compositions. Further yet, effervescent systems have been employed in contact lens cleaning compositions and other detergent compositions in the form of tablets. Still further yet, effervescent systems have been employed in toothpastes, mouthwash (mouth rinse), dentifrice and cosmetics in various physical forms.

There exists a need to provide a method for using a cleaning composition to allow for a simplification of the traditional hand dishwashing process for cleaning the toughest soils and allow for desired flexibility and convenience for the traditional hand dishwashing process. Such a method preferably allows enough flexibility for the user to fit the dishwashing into their schedule and have an ease of use. As discussed further herein, an aided soaking method, while providing the desired cleaning of the toughest soils and desired flexibility, consumers may be concerned about both cleaning efficacy and the redeposition of soils on the surfaces of the dishes. Therefore an additional need is to provide a method for using a cleaning composition that gives cleaning as well as shine benefits to dish surfaces.

### SUMMARY OF THE INVENTION

The present invention relates to a method of cleaning comprising the steps of: (a) adding an effervescent product to a volume of water; (b) contacting the volume of water with the effervescent product with soiled dishes; (c) soaking the soiled dishes in contact with the volume of water with the effervescent product for a desired period of time; (d) optionally wiping the dishes after the desired period of time; (e) optionally rinsing the dishes with water after the desired period of time; wherein the effervescent product is added such that a concentration of the effervescent product is between about 0.1 g/L and about 500 g/L and a pH of from about 6 to about 10 results.

The present invention further relates to the use of an effervescent product comprising an effervescent system, a surfactant system and optionally other components to clean a light or everyday load of soiled dishes.

### DETAILED DESCRIPTION OF THE INVENTION

“Effervescence” as used herein includes, but is not limited to, the formation of gas, gas bubbles, foam, mousse, etc. from the effervescent system as described herein.

As used herein, the term “dish” or “dishes” means any tableware (plates, bowls, glasses, mugs), cookware (pots, pans, baking dishes), glassware, silverware or flatware and cutlery, cutting board, food preparation equipment, etc. which is washed prior to or after contacting food, being used in a food preparation process and/or in the serving of food.

As used herein “light dish load” means the following number and type of dishes 2 dinner plates (30.5 cm diameter), 1 salad plate (12 cm diameter), 2 bowls (12.5 cm diameter, 4.5 cm depth), 2 glasses (250 mL volume), 2 mugs (250 mL volume), 2 sets of silverware (spoons, forks, knives), 1 larger silver spoon and 1 plastic stirring spoon. “Everyday dish load” means all the “light load” items, plus 1 frying pan (aluminum 21 cm diameter), 1 casserole dish (Pyrex®; 20 cm by 20 cm), 1 pot (aluminum, 12.5 cm diameter, 6 cm depth), and 1 plastic container (round, 500 mL volume).

As used herein “soils” or “tough soils” refers to the soils on dishes discussed further below in the test method section including oatmeal, corn flakes, macaroni and cheese, Italian salad dressing, mashed potatoes, hamburger, tomato sauce, milk, coffee, and hamburger grease.

As used herein “dry” means that a material, such as the effervescent product, is substantially free of water, i.e., that no water has been added or present other than the moisture of the raw materials themselves. Typically, the level of water is below 10% by weight of the total material and preferably below 5% by weight of the total material.

As used herein “wet” means that a material comprises a level of water above 10% by weight of the material.

As used herein “nonwoven substrate” can comprise any conventionally fashioned nonwoven sheet or web having suitable basis weight, caliper (thickness), absorbency and strength characteristics. Examples of suitable commercially available nonwoven substrates include those marketed under the tradename SONTARA® by DuPont and POLYWEB® by James River Corp.

As used herein “a volume of water” can be any volume of water to which the effervescent product may be added such that a concentration of the effervescent product is between about 0.1 g/L and about 500 g/L, such as about 0.1 g/L and about 300 g/L, such as 0.1 g/L to about 100 g/L. Non-limiting examples include water basins or sinks, buckets, bowls, pots, glasses, or any other dish that can hold more than 50 mL of water, such as 50 mL to about 20 L of water.

As used herein, the terms “foam” and “suds” are used interchangeably and indicate discrete bubbles of gas bounded by and suspended in a liquid phase.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the liquid detergent composition. All temperatures, unless otherwise indicated are in Celsius.

The present invention relates to the use of an effervescent product comprising an effervescent system and a surfactant system for cleaning soiled dishes in a volume of water. Additional optional components may be utilized such as binders, bleaching systems, enzymes, and soil release polymers.

The present invention relates to a method of cleaning having the steps of adding soiled dishes to a volume of water; adding an effervescent product to the volume of water; and soaking the soiled dishes in the volume of water with the effervescence product for a desired period of time. The method further optionally comprises wiping the dishes, spraying the dishes, and/or rinsing the dishes after the desired period of time.

The present invention also relates to the method of cleaning soiled dishes. The method first involves forming the effervescent product, including the effervescent product in packaging. Placing the effervescent product by the consumer into a volume of water. Allowing the effervescent product to stand in the volume of water, then placing soiled dishes into the volume of water for a desired period of time. Finally, rinsing away any residue with generous amounts of water from the dishes.

The present invention also relates to a method of soaking a light load of soiled dishes. The present invention also relates to a method of providing shine to soiled dishes.

The volume of water may be contained in a water basin, bucket, pot, glass or bowl. The volume of water is more than 50 mL, such as from about 1000 mL to about 20000 mL, more typically from about 5000 mL to about 15000 mL of water in a water basin, bucket, pot, glass or bowl. The water may be from about water source, for example any municipal, commercial, household or other available water source.

The effervescent product may contain enough actives such that the actives are present at a level of about 0.1 g/L to about 500 g/L, such as about 0.5 g/L to about 300 g/L, further such as 1 g/L to about 100 g/L after the desired period of time. The resulting pH of the effervescent product in the volume of water should be from about 6 to about 10. Actives may include the surfactant and any other optional component described herein. Preferably the product is substantially free of phosphate materials. As used herein “substantially free” means that the indicated material is present at levels less than about 0.5 wt % of the product, such as less than about 0.1 wt %, further such as 0.05 wt % by weight of the effervescent product.

The effervescent product may take several forms such as dry forms, including but not limited to tablets, rings, disks, stars, spheres, sticks, pellets, water soluble pouches such as those made with water soluble films (e.g., PVA), ribbons, briquettes, tabs, granules, powers, pastilles, flakes, sachets, pearls, beads, and impregnated nonwovens; wet forms such as liquids pastes, and gels; or multi-form products such as a wet and dry form combined into one product.

Dry forms, such as tablets should be formulated and/or manufactured such that they experience sufficient buoyancy that they at least remain suspended in the water, and rather than floating on the-surface of the water thereby causing gelling of the dry form on the water surface. The density of the dry form is preferably between about 1 and about 3 preferably between about 1.2 and about 1.5.

The effervescent product should be water soluble and be able to dissolve completely in a sufficient volume of water within a desired period of time. The effervescent product should also be able to give a “burst” of effervescent to signal the dissolution to the user. As used herein “desired period of time” means between about 0.5 and about 60 minutes, preferably from about 0.5 to about 20 minutes, preferably from about 0.5 to about 10 minutes. As used herein “burst” means that upon addition to a volume of water, the effervescent product releases gases immediately such that a user can visually see the effervescence.

Effervescent System

The effervescent product according to the present invention comprises an effervescent system. The effervescent system results in a very fast gas production, such as carbon dioxide, and therefore in accelerated dispersibility and dissolution rate of the composition. The effervescent system may comprise (1) an acid and carbonate combination for dry effervescent products and in liquid effervescent products (See U.S. Pat. No. 6,699,828 B1), (2) may comprise a pressurized gas system for liquid effervescent products, such as those discussed in U.S. Pat. No. 3,947,567, (3) non-pressurized gas systems such as those discussed in WO 2004092318 A1, (4) pressurized gas system or effervescent system for gels or pastes such as those discussed in U.S. Pat. No. 6,010,683, (5) a solvent or solvent system as an effervescent system or with an effervescent system such as that described in WO 2004/106477 A1, WO 2004/048505 A1 and U.S. Pat. No. 6,440,906 B1 for liquids; (6) A metal ion catalyst/substrate pairs include, such as iron and percarbonate and/or perborate, zinc and diethyloxaloacetate, manganese and diethyloxaloacetate, and manganese and carboxylic acid discussed in US 20030191043 A1; (7) an inorganic oxide material, e.g., microporous molecular sieves, having sufficient adsorbed gas such that when contained in an essentially anhydrous composition that is contacted with water that a release of the adsorbed gas occurs to provide an effervescent effect such as that discussed in U.S. Pat. No. 4,592,855, (8) and a water soluble gasified solid, encapsulating gases, such as carbon dioxide into a solid matrix of water soluble materials such as sugar, glucose, and lactose for solid effervescent products. See U.S. Pat. No. 6,358,493 B1 and U.S. Pat. No. 6,310,014 B1. The gasified solids can hold tiny pockets of carbon dioxide gas at pressures exceeding several hundred pounds per square inch. When the water soluble material is placed in water, thereby dissolving the solid structure, or when the water soluble material is mechanically abraded, thereby rupturing the solid matrix structure, the pressurized gas is released with a popping sound.

Acids

Suitable acids have a pKa of from about 1 to about 10. Nonlimiting examples to be used herein include organic, mineral or inorganic acids, salts or derivatives thereof or a mixture thereof. It may be preferred that the acids are mono-, bi- or tri-protonic acids. Such acids include mono- or polycarboxylic acids preferably citric acid, adipic acid, glutaric acid, 3 chetoglutaric acid, citramalic acid, tartaric acid, maleic acid, fumaric acid, malic acid, succinic acid, malonic acid. Such acids are preferably used in their acidic forms, and it may be preferred that their anhydrous forms are used, or mixtures thereof. Derivatives also include ester of the acids. U.S. Pat. No. 6,440,926, discussed using tararic, maleic and in particular malic acid as acids in for improved physical and/or chemical stability upon prolonged storage periods. Sulfamic acid is also suitable for use herein.

The acid is preferably present in at a level of from 0.1% to 99% by weight of the total granule, preferably from 3% to 75%, more preferably from 5% to 60% and most preferably from 15% to 50%.

Carbonate Source

Another feature of an acid and carbonate system is a carbonate source, including carbonate, bicarbonate and percarbonate salts, in particular bicarbonate and/or carbonate. Suitable carbonates to be used herein include carbonate and hydrogen carbonate of potassium, lithium, sodium, and the like amongst which sodium and potassium carbonate are preferred. Suitable bicarbonates to be used herein include any alkali metal salt of bicarbonate like lithium, sodium, potassium and the like, amongst which sodium and potassium bicarbonate are preferred. Bicarbonate may be preferred to carbonate, because it is more-weigh effective, i.e., at parity weigh bicarbonate is a larger CO₂ “reservoir” than carbonate. However, the choice of carbonate or bicarbonate or mixtures thereof may be made depending on the pH desired in the aqueous medium wherein the effervescent materials are dissolved. For example where a relative high pH is desired in the aqueous medium (e.g., above pH 9.5) it may be preferred to use carbonate alone or to use a combination of carbonate and bicarbonate wherein the level of carbonate is higher than the level of bicarbonate, typically in a weight ratio of carbonate to bicarbonate from 0.01 to 10, more preferably from 0.1 to 5 and most preferably from 0.1 to 2.

The carbonate source is preferably present at a level of from 0.1% to 99% by weight of the total, preferably from 30% to 95%, more preferably from 45% to 85% and most preferably from 50% to 80%.

A desired burst of effervescence upon initial addition of the effervescent product into the volume of water may be accomplished through the use of the effervescent system with an option dissolution aids such as those discussed in U.S. Pat. No. 6,232,284 B1, U.S. Pat. No. 6,169,062 B1, US 20030158073 A1, and EP 0 985 023 A1.

Surfactant

The type and amount of surfactant of the effervescent product must be chosen to achieve the desired level of cleaning and to achieve dissolution in a desired period of time. Surfactant a present in a level from about 10% to about 50% by weight, preferably from about 10% to about 40% by weight, preferably from about 10% to about 30% by weight of the effervescent product. In one embodiment, should an acid and carbonate effervescent system be utilized, a balance between the amount of surfactant and effervescent system must be obtained as surfactants tend to interfere with the effervescent system.

Amine Oxide Surfactants

A component used in the use of the present invention include linear, branched and mid-branched amine oxides. Amine oxides, for use herein, include water-soluble amine oxides containing one linear and/or branched (including a mid-branched) C₈₋₁₈ alkyl moiety and 2 moieties selected from the group consisting of C₁₋₃ alkyl groups and C₁₋₃ hydroxyalkyl groups; water-soluble phosphine oxides containing one C₁₀₋₁₈ alkyl moiety and 2 moieties selected from the group consisting of C₁₋₃ alkyl groups and C₁₋₃ hydroxyalkyl groups; and water-soluble sulfoxides containing one C₁₀₋₁₈ alkyl moiety and a moiety selected from the group consisting of C₁₋₃ alkyl and C₁₋₃ hydroxyalkyl moieties.

Preferred amine oxide surfactants have formula (II): 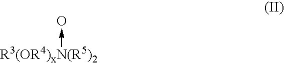
wherein R³ of formula (II) is a linear and/or branched C₈₋₂₂ alkyl, C₈₋₂₂ hydroxyalkyl, C₈₋₂₂ alkyl phenyl group, and mixtures thereof; R⁴ of formula (II) is an C₂₋₃ alkylene or C₂₋₃ hydroxyalkylene group or mixtures thereof; x is from 0 to about 3; and each R⁵ of formula (I) is an C₁₋₃ alkyl or C₁₋₃ hydroxyalkyl group or a polyethylene oxide group containing from about 1 to about 3 ethylene oxide groups. The R⁵ groups of formula (II) can be attached to each other, e.g., through an oxygen or nitrogen atom, to form a ring structure. As used herein “branched” mean a C₁-C₁₁ alkyl moiety.

As used herein “mid-branched” means that the amine oxide has one alkyl moiety having n₁ carbon atoms with one alkyl branch on the alkyl moiety having n₂ carbon atoms. The alkyl branch is located on the a carbon from the nitrogen on the alkyl moiety. This type of branching for the amine oxide is also known in the art as an internal amine oxide. The total sum of n₁ and n₂ is from 10 to 24 carbon atoms, preferably from 12 to 20, and more preferably from 10 to 16. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁-n₂| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C₁₋₃ alkyl, a C₁₋₃ hydroxyalkyl group, or a polyethylene oxide group containing an average of from about 1 to about 3 ethylene oxide groups. Preferably the two moieties are selected from a C₁₋₃ alkyl, more preferably both are selected as a C₁ alkyl.

These amine oxide surfactants in particular include C₁₀-C₁₈ alkyl dimethyl amine oxides and C₈-C₁₂ alkoxy ethyl dihydroxy ethyl amine oxides. Preferred amine oxides include linear and/or branched C₁₀, C₁₀-C₁₂, and C₁₂-C₁₄ alkyl dimethyl amine oxides.

At least one amine oxide will be present in the effervescent product from about 0.1% to about 15%, more preferably at least about 0.2% to about 12% by weight of the effervescent product. Most preferably, the amine oxide is present in the effervescent product from about 1% to about 8% by weight of the effervescent product.

Nonionic Surfactants

Optionally the nonionic surfactant, when present in the effervescent product, is present in an effective amount, more preferably from 0.1% to 20%, even more preferably 0.1% to 15%, even more preferably still from 0.5% to 10%, by weight of the effervescent product.

Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. Also suitable are alkylpolyglycosides having the formula R²O(CₙH₂ₙO)ₜ(glycosyl)ₓ (formula (III)), wherein R² of formula (III) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (III) is 2 or 3, preferably 2; t of formula (III) is from 0 to 10, preferably 0; and x of formula (III) is from 1.3 to 10, preferably from 1.3 to 3, most preferably from 1.3 to 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Also suitable are fatty acid amide surfactants having the formula (IV): 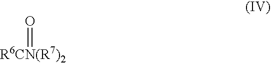
wherein R₆ of formula (IV) is an alkyl group containing from 7 to 21, preferably from 9 to 17, carbon atoms and each R⁷⁰f formula (IV) is selected from the group consisting of hydrogen, C₁-C₄ alkyl, C₁-C₄ hydroxyalkyl, and —(C₂H₄O)ₓH where x of formula (IV) varies from 1 to 3. Preferred amides are C₈-C₂₀ ammonia amides, monoethanolamides, diethanolamides, and isopropanolamides.

Typically, when present, nonionic surfactants comprise from about 0.01% to about 20%, preferably from about 0.5% to about 10% by weight of the effervescent product.

Ampholytic Surfactants

Other suitable, non-limiting examples of amphoteric detergent surfactants that are optional in the present invention include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group.

Typically, when present, ampholytic surfactants comprise from about 0.01% to about 20%, preferably from about 0.5% to about 10% by weight of the effervescent product.

Anionic Surfactants

Anionic surfactants are preferred components of the effervescent products of the present invention. Suitable anionic surfactants for use in the effervescent products herein include water-soluble salts or acids of C₆-C₂₀ linear or branched hydrocarbyl, preferably an alkyl (paraffin or olefin), hydroxyalkyl or alkylaryl, having a C₁₀-C₂₀ hydrocarbyl component, more preferably a C₁₀-C₁₆ alkyl or hydroxyalkyl, sulphate or sulphonates. Suitable counterions include hydrogen, alkali metal cation or ammonium or substituted ammonium, but preferably sodium.

Where the hydrocarbyl chain is branched, it preferably comprises C₁₋₄ alkyl branching units. The average percentage branching of the anionic surfactant is preferably greater than 30%, more preferably from 35% to 80% and most preferably from 40% to 60% of the total hydrocarbyl chains.

Alkyl glyceryl sulfonate surfactants and/or alkyl glyceryl sulfate surfactants generally used have high monomer content (greater than 60 wt % by weight of the alkyl glycerol sulfonate surfactant). As used herein “oligomer” includes dimer, trimer, quadrimer, and oligomers up to heptamers of alkyl glyceryl sulfonate surfactant and/or alkyl glyceryl sulfate surfactant. Minimization of the monomer content may be from 0 wt % to about 60 wt %, from 0 wt % to about 55 wt %, from 0 wt % to about 50 wt %, from 0 wt % to about 30 wt %, by weight of the alkyl glyceryl sulfonate surfactant and/or alkyl glyceryl sulfate surfactant present.

The alkyl glyceryl sulfonate surfactant and/or alkyl glyceryl sulfate surfactant for use herein include such surfactants having an alkyl chain length from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). Generally, the structures of suitable alkyl glyceryl sulfonate surfactant oligomers that may be used herein include (A) dimers; (B) trimers, and (C) tetramers:

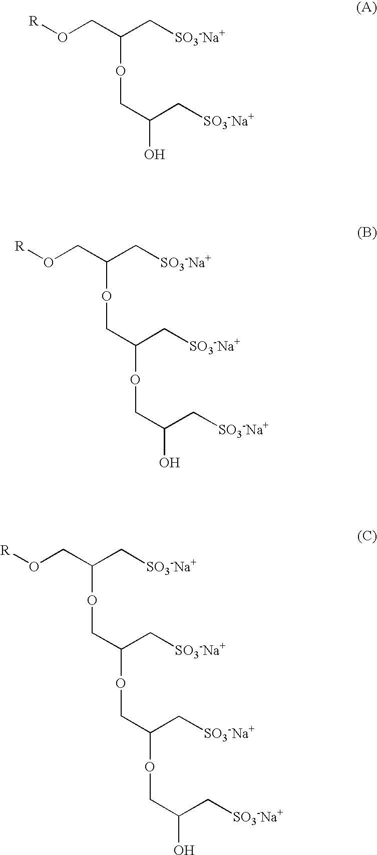

One of skill in the art will recognize that the counter-ion may be substituted with other suitable soluble cations other than the sodium shown above. R in the above structures (A)-(C) is from C₁₀₋₄₀, C₁₀₋₂₂, C₁₂₋₁₈, and C₁₆₋₁₈. The alkyl chain may be branched or linear, wherein when present, the branches comprise a C₁₋₄ alkyl moiety, such as methyl (C₁) or ethyl (C₂). One of skill in the art will also recognize that the corresponding alkyl glyceryl sulfate surfactant oligomers may also have similar structures with the SO₃⁻ moiety being an OSO₃⁻ moiety.

The alkyl glyceryl sulfonate surfactant and/or alkyl glyceryl sulfate surfactant oligomer content may be between about 40 wt % and 100 wt %, about 45 wt % and 100 wt %, about 50 wt % and 100 wt %, about 70 wt % and 100 wt % by weight of the alkyl glycerol sulfonate surfactant and/or alkyl glyceryl sulfate surfactant. As used herein, the “oligomer content” means the sum of the alkyl glyceryl sulfonate surfactant oligomers and/or alkyl glyceryl sulfate surfactant oligomers, such as dimers, trimers, quadrimers, and above (heptamers) present in the alkyl glyceryl sulfonate surfactant and/or alkyl glyceryl sulfate surfactant. More specifically, as shown below in Table I, nonlimiting examples of alkyl glyceryl sulfonate surfactant oligomer content demonstrates the weight percent of oligomers present and the minimization of the monomer content of the alkyl glyceryl sulfonate surfactant.

The anionic surfactant is optionally present at a level of at least 10%, more preferably from 10% to 40% and most preferably from 10% to 30% by weight of the effervescent product.

Nonionic Surfactants

Nonionic surfactants are optional components of the effervescent products of the present invention. Suitable nonionic surfactants for use in the effervescent products herein include alkylpolysaccharides disclosed in U.S. Pat. No. 4,565,647, Llenado, issued Jan. 21, 1986, having a hydrophobic group containing from 6 to 30 carbon atoms, preferably from 10 to 16 carbon atoms and a polysaccharide, e.g., a polyglycoside, hydrophilic group containing from 1.3 to 10, preferably from 1.3 to 3, most preferably from 1.3 to 2.7 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersacchalide bonds can be, e.g., between the one position of the additional saccharide units and the 2-, 3-, 4-, and/or 6-positions on the preceding saccharide units.

The preferred alkylpolyglycosides have the formula R²O(CₙH₂ₙO)ₜ(glycosyl), wherein R² is selected from the group consisting of alkyl, alkylphenyl, hydroxyalkyl, hydroxyalkylphenyl, and mixtures thereof in which the alkyl groups contain from 10 to 18, preferably from 12 to 14, carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominately the 2-position.

Optional Binder

The binder, when present, may be present in an amount from about 1% to about 5% by weight of the total weight of the effervescent product. In a preferred embodiment the binder is 3% by weight of the effervescent product. The binder that may be used is selected from, but is not limited to, the following: polyethylene glycol, sorbitol, maltodextrin or sugars (e.g., lactose, sucrose). Other suitable binders are those known to those skilled in the art and include anionic surfactants like C₆-C₂₀ alkyl or alkylaryl sulphonates or sulphates, preferably C₈-C₂₀ alkylbenzene sulphonates, nonionic surfactants, preferably C₁₀-C₂₀ alcohol ethoxylates containing from 5-100 moles of ethylene oxide per mole of alcohol and more preferably the C₁₅-C₂₀ primary alcohol ethoxylates containing from 20-100 moles of ethylene oxide per mole of alcohol. Of these tallow alcohol (TA) ethoxylated with 25 moles of ethylene oxide per mole of alcohol (TA(EO)₂₅) or 50 moles of ethylene oxide per mole of alcohol (TA(EO)₅₀) are preferred. Other preferred binders include the polymeric materials like polyvinylpyrrolidones with an average molecular weight of from 12 000 to 700 000 and polyethylene glycols with an average weight of from 600 to 10 000. Others binders further include C₁₀-C₂₀ mono and diglycerol ethers as well as C₁₀-C₂₀ fatty acids.

Optional Soil Suspending polymers

The composition comprises from about 0.01% to about 4% by weight of a soil suspending polymer selected from polyesters, polycarboxylates, saccharide based materials, modified celluloses, modified polyethyleneimines, modified hexamethylenediamine, polyamidoamines, branched polyaminoamines, hydrophobic polyamine ethoxylate polymers, polyamino acids, and mixtures thereof. The degree of polymerization for these materials, which is most easily expressed in terms of weight average molecular weight, is not critical provided the material has the desired water solubility and soil-suspending power. Suitable polymers will also, generally, have a water solubility of greater than 0.3% at normal usage temperatures.

Polyesters

Polyesters of terephthalic and other aromatic dicarboxylic acids having soil release properties such as polyethylene terephthalate/polyoxyethylene terephthalate and polyethylene terephthalate/polyethylene glycol polymers, among other polyester polymers, may be utilized as the soil suspending polymer in the present composition.

High molecular weight (e.g., 40,000 to 50,000 M.W.) polyesters containing random ethylene terephthalate/polyethylene glycol (PEG) terephthalate units have been used as soil release compounds in laundry detergent compositions. See U.S. Pat. No. 3,962,152 and U.S. Pat. No. 3,959,230. Sulfonated linear terephthalate ester oligomers are discussed in U.S. Pat. No. 4,968,451. U.S. Pat. No. 4,427,557, discloses low molecular weight copolyesters (M.W. 2,000 to 10,000) which can be used in aqueous dispersions to impart soil release properties to polyester fibers. The copolyesters are formed by the reaction of ethylene glycol, a PEG having an average molecular weight of 200 to 1000, an aromatic dicarboxylic acid (e.g. dimethyl terephthalate), and a sulfonated aromatic dicarboxylic acid (e.g. dimethyl 5-sulfoisophthalate). The PEG can be replaced in part with monoalkylethers of PEG such as the methyl, ethyl and butyl ethers.

Polyesters formed from: (1) ethylene glycol, 1,2-propylene glycol or a mixture thereof; (2) a polyethylene glycol (PEG) capped at one end with a C₁-C₄ alkyl group; (3) a dicarboxylic acid (or its diester); and optionally (4) an alkali metal salt of a sulfonated aromatic dicarboxylic acid (or its diester), or if branched polyesters are desired, a polycarboxylic acid (or its ester). The block polyester polymers are further discussed in U.S. Pat. No. 4,702,857.

U.S. Pat. No. 4,201,824, discloses hydrophilic polyurethanes having soil release and antistatic properties useful in detergent compositions. These polyurethanes are formed from the reaction product of a base polyester with an isocyanate prepolymer (reaction product of diisocyanate and macrodiol).

EP 0752468 B1 discloses a water-soluble copolymer providing soil release properties when incorporated in a laundry detergent composition, the copolymer comprising monomer units of poly(ethylene glycol) and/or capped poly(ethylene glycol) and monomer units of one or more aromatic dicarboxylic acids, characterized in that the copolymer comprises monomer units of poly(ethylene glycol) and/or capped poly(ethylene glycol); monomer units of one or more aromatic dicarboxylic acids wherein the aromatic is optionally sulphonated; and monomer units derived from a polyol having at least 3 hydroxyl groups,

Polycarboxylates

The present composition may comprise a polycarboxylate polymer or co-polymer comprising a carboxylic acid monomer. A water soluble carboxylic acid polymer can be prepared by polyimerizing a carboxylic acid monomer or copolymerizing two monomers, such as an unsaturated hydrophilic monomer and a hydrophilic oxyalkylated monomer. Examples of unsaturated hydrophilic monomers include acrylic acid, maleic acid, maleic anhydride, methacrylic acid, methacrylate esters and substituted methacrylate esters, vinyl acetate, vinyl alcohol, methylvinyl ether, crotonic acid, itaconic acid, vinyl acetic acid, and vinylsulphonate. The hydrophilic monomer may further be copolymerized with oxyalkylated monomers such as ethylene or propylene oxide. Preparation of oxyalkylated monomers is disclosed in U.S. Pat. No. 5,162,475 and U.S. Pat. No. 4,622,378. The hydrophilic oxyalkyated monomer preferably has a solubility of about 500 grams/liter, more preferably about 700 grams/liter in water. The unsaturated hydrophilic monomer may further be grafted with hydrophobic materials such as poly(alkene glycol) blocks. See, for example, materials discussed in U.S. Pat. No. 5,536,440, U.S. Pat. No. 5,147,576, U.S. Pat. No. 5,073,285, U.S. Pat. No. 5,534,183, and WO 03/054044.

Other polymeric polycarboxylates that are suitable include, for example, the polymers disclosed in U.S. Pat. No. 5,574,004. Such polymers include homopolymers and/or copolymers (composed of two or more monomers) of an alpha, beta-ethylenically unsaturated acid monomer such as acrylic acid, methacrylic acid, a diacid such as maleic acid, itaconic acid, fumaric acid, mesoconic acid, citraconic acid and the like, and a monoester of a diacid with an alkanol, e.g., having 1-8 carbon atoms, and mixtures thereof.

When the polymeric polycarboxylate is a copolymer, it can be a copolymer of more than one of the foregoing unsaturated acid monomers, e.g., acrylic acid and maleic acid, or a copolymer of at least one of such unsaturated acid monomers with at least one non-carboxylic alpha, beta-ethylenically unsaturated monomer which can be either relatively non-polar such as styrene or an olefinic monomer, such as ethylene, propylene or butene-1, or which has a polar functional group such as vinyl acetate, vinyl chloride, vinyl alcohol, alkyl acrylates, vinyl pyridine, vinyl pyrrolidone, or an amide of one of the delineated unsaturated acid monomers, such as acrylamide or methacrylamide.

Copolymers of at least one unsaturated carboxylic acid monomer with at least one non-carboxylic comonomer should contain at least about 50 mol % of polymerized carboxylic acid monomer. The polymeric polycarboxylate should have a number average molecular weight of, for example about 1000 to 10,000, preferably about 2000 to 5000. To ensure substantial water solubility, the polymeric polycarboxylate is completely or partially neutralized, e.g., with alkali metal ions, preferably sodium ions.

Saccharide Based Materials

The present composition may comprise a soil suspension polymer derived from saccharide based materials. Saccharide based materials may be natural or synthetic and include derivatives and modified saccharides. Suitable saccharide based materials include cellulose, gums, arabinans, galactans, seeds and mixtures thereof.

Saccharide derivatives may include saccharides modified with amines, amides, amino acids, esters, ethers, urethanes, alcohols, carboxylic acids, silicones, sulphonates, sulphates, nitrates, phosphates and mixtures thereof.

Modified celluloses and cellulose derivatives, such as carboxymethylcellulose, hydroxyethylcellulose, methyl cellulose, ethyl cellulose, cellulose sulphate, cellulose acetate (see U.S. Pat. No. 4,235,735), sulphoethyl cellulose, cyanoethyl cellulose, ethyl hydroxyethylcellulose, hydroxyethyl cellulose and hydroxypropylcellulose are suitable for use in the composition. Some modified celluloses are discussed in GB 1 534 641, U.S. Pat. No. 6,579,840 B1, WO 03/040279 and WO 03/01268. Another preferred example of a saccharine based soil suspending polymer suitable for use in the present invention includes polyol compounds comprising at least three hydroxy moieties, preferably more than three hydroxy moieties, most preferably six or more hydroxy moieties. At least one of the hydroxy moieties further comprising a alkoxy moiety, the alkoxy moiety is selected from the group consisting of ethoxy (EO), propoxy (PO), butoxy (BO) and mixtures thereof preferably ethoxy and propoxy moieties, more preferably ethoxy moieties. The average degree of alkoxylation is from about 1 to about 100, preferably from about 4 to about 60, more preferably from about 10 to about 40. Alkoxylation is preferably block alkoxylation.

The polyol compounds useful in the present invention further have at least one of the alkoxy moieties comprising at least one anionic capping unit. Further modifications of the compound may occur, but one anionic capping unit must be present in the compound of the present invention. One embodiment comprises more than one hydroxy moiety further comprising an alkoxy moiety having an anionic capping unit. For example such as the shown in the formula:

wherein x of the anionic capped polyol compound is from about 1 to about 100, preferably from about 10 to about 40.

Suitable anionic capping unit include sulfate, sulfosuccinate, succinate, maleate, phosphate, phthalate, sulfocarboxylate, sulfodicarboxylate, propanesultone, 1,2-disulfopropanol, sulfopropylamine, sulphonate, monocarboxylate, methylene carboxylate, ethylene carboxylate, carbonates, mellitic, pyromellitic, sulfophenol, sulfocatechol, disulfocatechol, tartrate, citrate, acrylate, methacrylate, poly acrylate, poly acrylate-maleate copolymer, and mixtures thereof. Preferably the anionic capping units are sulfate, sulfosuccinate, succinate, maleate, sulfonate, methylene carboxylate and ethylene carboxylate. Suitable polyol compounds for starting materials for use in the present invention include maltitol, sucrose, xylitol, glycerol, pentaerythitol, glucose, maltose, matotriose, maltodextrin, maltopentose, maltohexose, isomaltulose, sorbitol, poly vinyl alcohol, partially hydrolyzed polyvinylacetate, xylan reduced maltotriose, reduced maltodextrins, polyethylene glycol, polypropylene glycol, polyglycerol, diglycerol ether and mixtures thereof. Preferably the polyol compound is sorbitol, maltitol, sucrose, xylan, polyethylene glycol, polypropylene glycol and mixtures thereof. Preferably the starting materials are selected from sorbitol, maltitol, sucrose, xylan, and mixtures thereof.

Modification of the polyol compounds is dependant upon the desired formulability and performance requirements. Modification can include incorporating anionic, cationic, or zwitterionic charges to the polyol compounds. In one embodiment, at least one hydroxy moiety comprises an alkoxy moiety, wherein at least one alkoxy moiety further comprises at least one anionic capping unit. In another embodiment, at least one hydroxy moiety comprises an alkoxy moiety, wherein the alkoxy moiety further comprises more than one anionic capping unit, wherein at least one anionic capping unit, but less than all anionic capping units, is then selectively substituted by an amine capping unit. The amine capping unit is selected from a primary amine containing capping unit, a secondary amine containing capping unit, a tertiary amine containing capping unit, and mixtures thereof.

The polyol compounds useful in the present invention further have at least one of the alkoxy moieties comprising at least one amine capping unit. Further modifications of the compound may occur, but one amine capping unit must be present in the compound of the present invention. One embodiment comprises more than one hydroxy moiety further comprising an alkoxy moiety having an amine capping unit. In another embodiment, at least one of nitrogens in the amine capping unit is quaternized. As used herein “quaternized” means that the amine capping unit is given a positive charge through quaternization or protonization of the amine capping unit. For example, bis-DMAPA contains three nitrogens, only one of the nitrogens need be quaternized. However, it is preferred to have all nitrogens quaternized on any given amine capping unit.

Suitable primary amines for the primary amine containing capping unit include monoamines, diamine, triamine, polyamines, and mixtures thereof. Suitable secondary amines for the secondary amine containing capping unit include monoamines, diamine, triamine, polyamines, and mixtures thereof. Suitable tertiary amines for the tertiary amine containing capping unit include monoamines, diamine, triamine, polyamines, and mixtures thereof.

Suitable monoamines, diamines, triamines or polyamines for use in the present invention include ammonia, methyl amine, dimethylamine, ethylene diamine, dimethylaminopropylamine, bis dimethylaminopropylamine (bis DMAPA), hexemethylene diamine, benzylamine, isoquinoline, ethylamine, diethylamine, dodecylamine, tallow triethylenediamine, mono substituted monoamine, monosubstituted diamine, monosubstituted polyamine, disubstituted monoamine, disubstiuted diamine, disubstituted polyamine, trisubstituted triamine, tri substituted polyamine, multisubstituted polyamine comprising more than three substitutions provided at least one nitrogen contains a hydrogen, and mixtures thereof.

In another embodiment, at least one of nitrogens in the amine capping unit is quaternized. As used herein “quaternized” means that the amine capping unit is given a positive charge through quaternization or protonization of the amine capping unit. For example, bis-DMAPA contains three nitrogens, only one of the nitrogens need be quaternized. However, it is preferred to have all nitrogens quaternized on any given amine capping unit.

Modified Polyethyleneimine Polymer

The present composition may comprise a modified polyethyleneimine polymer. The modified polyethyleneimine polymer has a polyethyleneimine backbone having a molecular weight from about 300 to about 10000 weight average molecular weight, preferably from about 400 to about 7500 weight average molecular weight, preferably about 500 to about 1900 weight average molecular weight and preferably from about 3000 to 6000 weight average molecular weight.

The modification of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom on by a polyalkoxylene chain having an average of about 1 to about 40 alkoxy moieties per modification, wherein the terminal alkoxy moiety of the alkoxylation modification is capped with hydrogen, a C₁-C₄ alkyl, sulfates, carbonates, or mixtures thereof; (2) a substitution of one C₁-C₄ alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof.

For example, but not limited to, below is shown possible modifications to terminal nitrogen atoms in the polyethyleneimine backbone where R represents an ethylene spacer and E represents a C₁-C₄ alkyl moiety and X⁻ represents a suitable water soluble counterion.

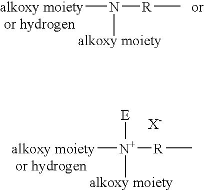

Also, for example, but not limited to, below is shown possible modifications to internal nitrogen atoms in the polyethyleneimine backbone where R represents an ethylene spacer and E represents a C₁-C₄ alkyl moiety and X− represents a suitable water soluble counterion.

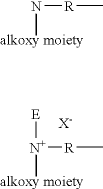

The alkoxylation modification of the polyethyleneimine backbone consists of the replacement of a hydrogen atom by a polyalkoxylene chain having an average of about 1 to about 40 alkoxy moieties, preferably from about 5 to about 20 alkoxy moieties. The alkoxy moieties are selected from ethoxy (EO), 1,2-propoxy (1,2-PO), 1,3-propoxy (1,3-PO), butoxy (BO), and combinations thereof. Preferably, the polyalkoxylene chain is selected from ethoxy moieties and ethoxy/propoxy block moieties. More preferably, the polyalkoxylene chain is ethoxy moieties in an average degree of from about 5 to about 15 and the polyalkoxylene chain is ethoxy/propoxy block moieties having an average degree of ethoxylation from about 5 to about 15 and an average degree of propoxylation from about 1 to about 16. Most preferable the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized. Modified polyethyleneimine polymers are also described in U.S. Pat. No. 5,565,145.

Modified Hexamethylenediamine

The present composition may comprise a modified hexamentylenediamine. The modification of the hexamentylenediamine includes: (1) one or two alkoxylation modifications per nitrogen atom of the hexamentylenediamine. The alkoxylation modification consisting of the replacement of a hydrogen atom on the nitrogen of the hexamentylenediameine by a (poly)alkoxylene chain having an average of about 1 to about 40 alkoxy moieties per modification, wherein the terminal alkoxy moiety of the alkoxylene chain is capped with hydrogen, a C₁-C₄ alkyl, sulfates, carbonates, or mixtures thereof; (2) a substitution of one C₁-C₄ alkyl moiety and one or two alkoxylation modifications per nitrogen atom of the hexamentylenediamine. The alkoxylation modification consisting of the replacement of a hydrogen atom by a (poly)alkoxylene chain having an average of about 1 to about 40 alkoxy moieties per modification wherein the terminal alkoxy moiety of the alkoxylene chain is capped with hydrogen, a C₁-C₄ alkyl or mixtures thereof; or (3) a combination thereof. The alkoxylation may be in the form of ethoxy, propoxy, butoxy or a mixture thereof. U.S. Pat. No. 4,597,898,

A preferred modified hexamethylenediamine has the general structure below: 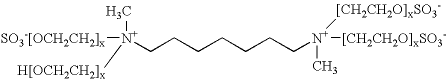
wherein x is from about 20 to about 30 and approximately 40% of the (poly)alkoxylene chain terminal alkoxy moieties are sulfonated.

A preferred modified hexamethylenediamine has the general structure below: 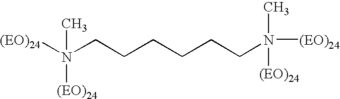
available under the tradename LUTENSIT® from BASF and such as those described in WO 01/05874.
Branched Polyaminoamines

A preferred example of a surfactant boosting polymer is exemplified in structural formula below: 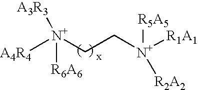
where x of the polyaminoamine can be from 1 to 12, more preferably from 1 to 8, more preferably from 1 to 6 and even more preferably from 1 to 4, R₅ and R₆ of the polyaminoamine may not be present (at which case N is neutral), and/or may be independently chosen from group of H, aliphatic C₁-C₆, alkylene C₂-C₆, arylene, or alkylarylene, R₁, R₂, R₃, and R₄ of the polyaminoamine are independently chosen from the group of H, OH, aliphatic C₁-C₆, alkylene C₂-C₆, arylene, or alkylarylene, preferably at least one or more block of polyoxyalkylene C₂-C₅, and single and/or repeating block units of linear or branched alkylene (C₁-C₂₀), linear or branched oxyalkylene (C₂-C₅) and mixtures of thereof. A₁, A₂, A₃, A₄, A₅, and A₆_{_{—}} of the polyaminoamine are capping groups independently selected from hydrogen, hydroxy, sulfate, sulfonate, carboxylate, phosphate, and mixtures thereof. If R₁, R₂, R₃, or R₄ are N(CH₂)ₙCH₂, than it represent continuation of this structure by branching. See also U.S. Pat. No. 4,597,898; U.S. Pat. No. 4,891,160; U.S. Pat. No. 5,565,145; and U.S. Pat. No. 6,075,000. The average degree of alkoxylation can also be more than 7, preferably from about 7 to about 40.
Hydrophobic Polyamine Ethoxylate Polymers

Soil suspending polymer for the composition may include hydrophobic polyamine ethoxylate polymers characterized by comprising a general formula:

R of the hydrophobic polyamine ethoxylate polymer is a linear or branched C₁-C₂₂ alkyl, a linear or branched C₁-C₂₂ alkoxyl, linear or branched C₁-C₂₂ acyl, and mixtures thereof; if R is selected as being branched, the branch may comprise from 1 to 4 carbon atoms; preferably R of the hydrophobic polyamine ethoxylate polymer is a linear C₁₂ to C₁₈ alkyl. The alkyl, alkoxyl, and acyl may be saturated or unsaturated, preferably saturated. The n index of the hydrophobic polyamine ethoxylate polymer is from about 2 to about 9, preferably from about 2 to about 5, most preferably 3.

Q of the hydrophobic polyamine ethoxylate polymer is independently selected from an electron pair, hydrogen, methyl, ethyl, and mixtures thereof. If the formulator desires a neutral backbone of the hydrophobic polyamine ethoxylate, Q of the hydrophobic polyamine ethoxylate polymer should be selected to be an electron pair or hydrogen. Should the formulator desire a quaternized backbone of the hydrophobic polyamine ethoxylate; at least on Q of the hydrophobic polyamine ethoxylate polymer should be chosen from methyl, ethyl, preferably methyl. The m index of the hydrophobic polyamine ethoxylate polymer is from 2 to 6, preferably 3. The index x of the hydrophobic polyamine ethoxylate polymer is independently selected to average from about 1 to about 70 ethoxy units, preferably an average from about 20 to about 70, preferably about 30 to about 50, for polymers containing non-quaternized nitrogens; preferably from about 1 to about 10 for polymers containing quaternized nitrogens. The ethoxy units of the hydrophobic polyamine ethoxylate may be further modified by independently adding an anionic capping unit to any or all ethoxy units. Suitable anionic capping units include sulfate, sulfosuccinate, succinate, maleate, phosphate, phthalate, sulfocarboxylate, sulfodicarboxylate, propanesultone, 1,2-disulfopropanol, sulfopropylamine, sulphonate, monocarboxylate, methylene carboxylate, carbonates, mellitic, pyromellitic, citrate, acrylate, methacrylate, and mixtures thereof. Preferably the anionic capping unit is a sulfate.

In another embodiment, the nitrogens of the hydrophobic polyamine ethoxylate polymer are given a positive charge through quaternization. As used herein “quaternization” means quaternization or protonization of the nitrogen to give a positive charge to the nitrogens of the hydrophobic polyamine ethoxylate.

Polyamino Acids

The soil suspending polymers can be derived from L-glumatic acid, D-glumatic acid or mixtures, e.g. racemates, of these L and D isomers. The polymers include not only the homopolymers of glutamic acid but also copolymers, such as block, graft or random copolymers, containing glutamic acid. These include, for example, copolymers containing at least one other amino acid, such as aspartic acid, ethylene glycol, ethylene oxide, (or an oligimer or polymer of any of these) or polyvinyl alcohol. Glutamic acid can, of course, carry one or more substituents including, for example, alkyl, hydroxy alkyl, aryl and arylalkyl, commonly with up to 18 carbon atoms per group, or polyethylene glycol attached by ester linkages. See U.S. Pat. No. 5,470,510 A, issued Nov. 28, 1995.

Optional Anti-Filming Polymer

Carbonate and phosphate scale are troublesome in dishwashing applications because they lead to unsightly residues, or films, on dishware, tableware and especially glassware. This phenomenon is widely known as “hard water film”. Hence, “anti-filming technologies” to reduce the formation of carbonate or phosphate scale in automatic dishwashing have been extensively described in the literature.

Typically such anti-filming technologies have comprised polycarboxylates such as polyacrylates, polymethyacrylates, etc. as described in U.S. Pat. No. 5,591,703 and references described therein. Polycarboxylate technologies significantly assist in the reduction of hard water filming. Another class of anti-filming materials to reduce phosphate and carbonate scale is the sulfonate/carboxylate copolymers as described in U.S. Pat. No. 5,547,612, U.S. Pat. No. 6,395,185 and references described therein. Commercially available examples of such polymers include ALCOSPERSE® 240 (Alco Chemical), and ACUSOL® 586 (Rohm & Haas). The copolymers described in the art are typically derived from combinations of sulfonate-containing and/or carboxylate-containing ethylenically unsaturated monomers, such as acrylic acid, methylallylsulfonic acid, ethoxylate esters of acrylic acids, and variations thereof. A wide variety of such monomers, additional nonionic and/or cationic comonomers, and combinations have been described in the art. See also the materials described in WO 04/061067.

Optional Components

Stabilizing agent for the effervescent system, such as those discussed in U.S. Pat. No. 6,300,302 B1, US 20040127388 A1, CA 2311482 and JP 10-204500 A, dissolution aids such as those discussed in U.S. Pat. No. 6,232,284B1, U.S. Pat. No. 6,169,062B1, US 20030158073A1, and EP0985023A1, germicides such as those discussed in US 20040116317 A1 and US 20040127389 A1, suds boosting polymers, suds stabilizing materials, hydrotopes, solvents, thickeners, processing aids, enzymes, enzyme stabilizers, bleach, bleach stabilizers, perfumes, dyes, opacifiers, and pH buffering means.

Enzymes

Enzymes can be included in effective amounts in the composition herein. As used herein, an “effective amount” is an amount of additional enzyme to achieve the desired removal of a soil from the dish surface.

Examples of suitable enzymes include, but are not limited to, hemicellulases, peroxidases, proteases, cellulases, xylanases, lipases other than those described above, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents.

A potential enzyme combination comprises a cocktail of conventional detersive enzymes like protease, lipase, cutinase and/or cellulase in conjunction with amylase. Detersive enzymes are described in greater detail in U.S. Pat. No. 6,579,839. Particularly preferred compositions herein contain from 0.01% to about 0.5% by weight of the composition of enzymes.

Proteases useful herein include those like subtilisins from Bacillus [e.g. subtilis, lentus, licheniformis, amyloliquefaciens (BPN, BPN′), alcalophilus,] e.g. ESPERASE®, ALCALASE®, EVERLASE® and SAVINASE® (Novozymes), BLAP and variants (Henkel). Further proteases are described in EP130756, WO91/06637, WO95/10591 and WO99/20726.

Amylases (α and/or β) are described in WO 94/02597 and WO 96/23873. Commercial examples are PURAFECT OX AM® (Genencor) and TERMAMYL®, NATALASE®, BAN®, FUNGAMYL® and DURAMYL® (all ex Novozymes). Amylases also include, for example, α-amylases described in British Patent Specification No. 1,296,839 (Novozymes), and RAPIDASE® (International Bio-Synthetics, Inc).

The cellulases usable in the present composition include either bacterial or fungal cellulase. Preferably, they will have a pH optimum of between 5 and 9.5. Suitable cellulases are disclosed in U.S. Pat. No. 4,435,307, Barbesgoard et al, issued Mar. 6, 1984. Cellulases useful herein include bacterial or fungal cellulases, e.g. produced by Humicola insolens, particularly DSM 1800, e.g. 50 Kda and ^{˜}43 kD (CAREZYME®). Also suitable cellulases are the EGIII cellulases from Trichoderma longibrachiatum.

Other suitable lipases not described above include those produced by Pseudomonas and Chromobacter groups. The LIPOLASE® enzyme derived from Humicola lanuginosa and commercially available from Novozymes (see also EPO 41,947) is a suitable lipase for use herein. Also suitable are e.g., LIPOLASE ULTRA®, LIPOPRIME® and LIPEX® from Novozymes. Also suitable are cutinases [EC 3.1.1.50] and esterases. See also lipases in Japanese Patent Application 53-020487, laid open to public inspection on Feb. 24, 1978. This lipase is available from Areario Pharmaceutical Co. Ltd., Nagoya, Japan, under the trade name LIPASE P “AMANO®”. Other commercial lipases include AMANO-CES®, lipases ex Chromobacter viscosum, e.g. Chromobacter viscosum var. lipolyticum NRRLB 3673, commercially available from Toyo Jozo Co., Tagata, Japan; and further Chromobacter viscosum lipases from U.S. Biochemical Corp., U.S.A. and Diosynth Co., Netherlands, and other lipases such as Pseudomonas gladioli. Further suitable lipases are described in WO 2004/101759, WO 2004/101760 and WO 2004/101763.

Carbohydrases useful herein include mannanase (e.g., those disclosed in U.S. Pat. No. 6,060,299), pectate lyase (e.g., those disclosed in WO 99/27083), cyclomaltodextringlucanotransferase (e.g., those disclosed in WO 96/33267), xyloglucanase (e.g., those disclosed in WO 99/02663).

Bleaching enzymes useful herein with enhancers include peroxidases, laccases, oxygenases, (e.g., catechol 1,2 dioxygenase), lipoxygenase (e.g., those disclosed in WO 95/26393), and (non-heme) haloperoxidases.

Bleach System

The compositions of the present invention may optionally include from about 0.1 wt % to about 20 wt % by weight of the composition of a bleaching system. Non-limiting examples of bleaching systems include hypohalite bleaches, peroxygen bleaching systems, or transition metal nil peroxygen systems. Peroxygen systems typically comprise a “bleaching agent” (source of hydrogen peroxide) and an “initiator” or “catalyst”, however, pre-formed bleaching agents are included. Catalysts for peroxygen systems can include transition metal systems. In addition, certain transition metal complexes are capable of providing a bleaching system without the presence of a source of hydrogen peroxide.

Hydrogen peroxide sources are described in detail in the herein incorporated Kirk Othmer's Encyclopedia of Chemical Technology, 4th Ed (1992, John Wiley & Sons), Vol. 4, pp. 271-300 “Bleaching Agents (Survey)”, and include the various forms of sodium perborate and sodium percarbonate, including various coated and modified forms.

Non-limiting examples of activators are selected from the group consisting of tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C₁₀-OBS), benzoylvalerolactam (BZVL), octanoyloxybenzenesulphonate (C₈-OBS), perhydrolyzable esters and mixtures thereof.

The cleaning compositions of the present invention optionally comprise a bleaching system which contains one or more bleach catalysts. Selected bleach catalysts inter alia 5,12-dimethyl-1,5,8,12-tertaaza-bicyclo[6.6.2]hexadecane manganese (II) chloride may be formulated into bleaching systems which do not require a source of hydrogen peroxide or peroxygen bleach.

Dyes

In addition to traditional dyes, the effervescent composition of the present invention may optionally include an effective amount of a metal-complexing dye in an uncomplexed form, preferably from 0.001% to 0.5%, such as from 0.01% to 0.2%, further from 0.01% to 0.1% by weight of the composition. As used herein “uncomplexed” means that the metal-complexing dye has not interacted with a metal ion to give a visual indication. The metal-complexing dye should be selected to complex with alkaline earth metal ions, rare earth metal ions, transition metal ions and mixtures thereof. Preferably the metal-complexing dye is selected to complex with calcium, magnesium or iron ions as these are commonly found in water available to users of the composition.

The metal-complexing dye should be compatible in a composition and maintain a transparent visual appearance in the composition without interfering with traditional dyes in a composition. As used herein “compatible” means that the metal-complexing dye does not have a negative impact upon aesthetic or functional aspects of the composition. For example, the metal-complexing dye should not crash out of formulation or cause phase separation of the composition, nor should is destroy or interfere with the other components of the composition in their intended functions.

When the composition is added to a volume of water, the composition should give a visual indication when the metal complexing dye complexes with a metal ion, preferably a metal ion present in the volume of water. The color change is preferably characterized by a solution absorption wavelength of λmax=500 to 650 nm, and more preferably 545 to 650 nm. Without being limited by a theory, it is believed that these wavelengths, which correspond to the visual appearance of blue and green colors for the solution, indicate to users of the composition that the volume of water is “clean” by masking the color of soil in the volume of water such that the volume of water with the composition may still be utilized to wash or rinse items being cleaned or rinses. Such a visual indication may also be used to enhance the color of suds to present a whiter, more attractive appearance to the suds. Suitable metal-complexing dyes are further discussed in US 2006/0073999A1.

Test Methods

Soiled dishes may be produced by the following means for a light dish load and an everyday dish load.

TABLE I

| Dishware | Food item | Preparation |
|---|---|---|
| Casserole | Macaroni & | Preheat a convection oven to 191° C. (375° F.). Follow the |
| dish | Cheese | preparation directions on the package of macaroni & cheese, |
| | | place in the casserole dish, then bake for one hour. |
| Frying pan | Hamburger, | Cook hamburger in the frying pan and then pour off grease |
| | Tomato sauce | into the plastic container, then add (how much) tomato sauce, |
| | | simmer 3-5 minutes minutes, then place the mixture on a plate |
| Plastic | Hamburger | Pour some of grease off hamburger as described above, allow |
| container | grease | to cool in the plastic container |
| Pot | Mashed | Follow preparation directions on the package of mashed |
| | Potatoes | potatoes for 2 servings, place the potatoes on plate and keep |
| | | pot for cleaning |
| 2 dinner | Spaghetti | Place spaghetti sauce on one side of the plate and mashed |
| plates | sauce, | potatoes on other side of the plate, allow the plates to stand for |
| | Mashed | 1 to 3 hours and then scrape off the potatoes and any excess |
| | potatoes | spaghetti sauce from the plate. |
| Salad plate | Spaghetti | Use to hold all cooking utensils from preparing the spaghetti |
| | sauce, | sauce and mashed potatoes |
| | Mashed | |
| | potatoes | |
| Bowl #1 | Italian | Pour in, allow to stand for 1 to 3 hours, pour out |
| | dressing | |
| Bowl #2 | Microwave | Prepare oatmeal per the instruction on microwave oatmeal |
| | oatmeal | package, allow to stand for 1 to 3 hours, then scrape out |
| | | oatmeal from the bowl. |
| Bowl #3 | Corn Flakes | Add corn flakes and 200 mL milk to the bowl, pour out from |
| | | the bowl and allow to stand until residual flakes are visually |
| | | dry. |
| Glass #1 | Milk | Fill glass with milk, allow to stand for 1 to 3 hours, then pour |
| | | out the milk from the glass. |
| Glass #2 | Orange juice | Fill glass with orange juice, allow to stand for 1 to 3 hours, |
| | | then pour out the orange juice from the glass. |
| 2 mugs | Coffee | Prepare coffee according to package instructions. Fill mug |
| | | with prepared liquid coffee, allow to stand for 1 to 3 hours, |
| | | then pour out coffee from the mugs. |
| Plastic | Mashed | Use to prepare instant mashed potatoes as described above, |
| stirring | potatoes | then place on salad plate. |
| spoon | | |
| Large | Hamburger | Use to prepare hamburger as described above, the place on |
| silver | | salad plate. |
| spoon | | |
| Silverware | spaghetti | Use silverware (spoons, knives, forks) for scraping, preparing, |
| | sauce, | or other uses as described above. |
| | mashed | |
| | potatoes, | |
| | microwave | |
| | oatmeal | |

Washing Steps

Prepare a solution of 5 L of deionized water adjusted to a 7 gpg hardness and 100 ppm bicarbonate. Heat the solution to 48.9° C. (120° F.). Add any one of the effervescent formulations shown in Table II below, to make a concentration of the effervescent product is between about 0.1 g/L and about 500 g/L. Allow the detergent solution to cool to a temperature of 46.1° C. (115° F.). Add the soiled dishes prepared as described in Table I to the 46.1° C. (115° F.) detergent solution such that the dishes are submerged and soak between about 0.5 and about 60 minutes. Remove the sample from the detergent solution. Wet a sponge with the detergent solution and wipe over the dish surface having the twice (once forward and once backwards). Rinse the dish in distilled water. Allow the sample to dry for 12 to 14 hours at room temperature (25° C.).

Formulations

TABLE II

| | A | B | C | D | E | F |
|---|---|---|---|---|---|---|
| Ingredients | Wt % | Wt % | Wt % | Wt % | Wt % | Wt % |
| AES/LAS¹ | 15 | 15 | 8 | 25 | 25 | 12 |
| Linear Amine | 3 | 0 | 0 | 6 | 0 | 0 |
| Oxide² | | | | | | |
| Branched Amine | 0 | 3 | 0 | 0 | 6 | 0 |
| Oxide³ | | | | | | |
| Paraffin | 0 | 0 | 10 | 0 | 0 | 19 |
| Sulphonate⁴ | | | | | | |
| Sodium Xylene | 2 | 2 | 2 | 3 | 3 | 3 |
| Sulfonate | | | | | | |
| Citric Acid | 30 | 30 | 30 | 25 | 25 | 25 |
| Sodium | 42 | 42 | 42 | 35 | 35 | 35 |
| Carbonate/Bicarbonate | | | | | | |
| Alkyl Glycerol | 0-3 | 0-3 | 0-3 | 0-5 | 0-5 | 0-5 |
| Sulfonate | | | | | | |
| Soil Suspension | 0-3 | 0-3 | 0-3 | 0-5 | 0-5 | 0-5 |
| Polymer(s)⁵ | | | | | | |
| NOBS/TAED/Perborate/ | 0-3 | 0-3 | 0-3 | 0-5 | 0-5 | 0-5 |
| Percarbonate | | | | | | |
| Enzymes⁶ | 0-0.5 | 0-0.5 | 0-0.5 | 0-0.5 | 0-0.5 | 0-0.5 |
| Dyes | 0.3 | 0.3 | 0.3 | 0.3 | 0.3 | 0.3 |
| Perfumes | 0.2 | 0.2 | 0.2 | 0.3 | 0.3 | 0.3 |
| Water | 0-10 | 0-10 | 0-10 | 0-10 | 0-10 | 0-10 |
| Sodium Sulfate | Balance to | Balance | Balance | Balance | Balance to | Balance to |
| | 100% | to 100% | to 100% | to 100% | 100% | 100% |

¹AES is C₁₂₋₁₃ alkyl ethoxyl sulfonate containing an average of 0.6 ethoxy groups; LAS is a linear C₁₀₋₁₄ alkyl benezene sulfonate surfactant.
²C₁₂-C₁₄ dimethyl amine oxide
³a mid-branched amine oxide surfactant comprising one alkyl moiety having n1 carbon atoms and having one alkyl branch having n2 carbon atoms where the alkyl branch is located on the α carbon from the nitrogen and the sum of n1 and n2 is from 10 to 24 carbons, as discussed in US provisional application No. 60/627934, filed Nov. 15, 2004 (Attorney Docket No. 9766P).
⁴a secondary C₁₀-C₁₈ alkane sulfonate, such as those available from Clariant.
⁵any of the soil release polymers described herein above.
⁶one or more enzymes such as: Protease - SAVINASE ®; by Novozyme or as described in WO 95/10591, sold by Genencor Int. Inc.
Alcalase - as sold by NOVO Industries A/S
Cellulase - as sold by NOVO Industries A/S under the tradename CAREZYME ®.
Amylase - Amylolytic as sold by NOVO Industries A/S under the tradename TERMAMYL 120T ®; Amylolytic enzyme, as disclosed in PCT/US9703635, and G-ZYME ® available from Genencor Int. Inc..
Lipase - Lipolytic enzyme, having 2.0% by weight of active enzyme, sold by NOVO Industries A/S under the tradename LIPOLASE ®; LIPOLASE ULTRA ® or LIPEX ®
Endolase - Endoglucanase enzyme, having 1.5% by weight of active enzyme, sold by NOVO Industries A/S.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of cleaning comprising the steps of:
(a) adding an effervescent product to a volume of water;
(b) contacting the volume of water with the effervescent product with soiled dishes;
(c) soaking the soiled dishes in contact with the volume of water with the effervescent product for a desired period of time;
(d) optionally wiping the dishes after the desired period of time;
(e) optionally rinsing the dishes with water after the desired period of time;
wherein the effervescent product is added such that a concentration of the effervescent product is between about 0.1 g/L and about 500 g/L and a pH of from about 6 to about 10 results.

2. The method of claim 1 wherein the desired period of time is from about 0.5 to about 60 minutes, preferably from about 0.5 to about 20 minutes, preferably from about 0.5 to about 10 minutes.

3. The method of claim 1 wherein the volume of water is more than 50 mL, preferably from about 1000 mL to about 20000 mL, more preferably from about 5000 mL to about 15000 mL of water.

4. The method of claim 1 wherein the effervescent product comprises an effervescent system selected from the group consisting of:
(a) an acid and carbonate combination;
(b) a pressurized gas systems;
(c) a non-pressurized gas system;
(d) a solvent system;
(e) a metal ion catalyst and substrate pair;
(f) an inorganic oxide material;
(g) a water soluble gasified soiled; and
(h) mixtures thereof.

5. The method of claim 1 wherein the effervescent product comprises from about 10% to about 50% by weight of the effervescent product of a surfactant system.

6. The method of claim 1 wherein the effervescent product comprises from about 0.01% to about 4% by weight of a soil suspending polymer.

7. The method of claim 4 wherein the effervescent product comprises an acid and carbonate combination as the effervescent system and from about 0.1% to about 15% by weight of the effervescent product of a linear amine oxide, branched amine oxide, and mixtures thereof, and from about 10% to about 40% by weight of the effervescent product of an anionic surfactant.

8. The method of claim 4 wherein the effervescent product further comprises an optional component selected from the group comprising a stabilizing agent, a dissolution aid, a germicide, a suds boosting polymer, a suds stabilizing polymer, a hydrotrope, enzymes, enzyme stabilizers, bleach, bleach activators, perfume, dyes, pH buffering means, and mixtures thereof.

9. The use of an effervescent product comprising an effervescent system, a surfactant system and optionally other components to clean soiled dishes.
